(19) United States
(12) Patent Application Publication
(10) Pub. No.: US 2026/0356713 A1
(43) Pub. Date: Nov. 12, 2026

(54) APPARATUS AND METHOD FOR THE TREATMENT OF WASTEWATER USING PHOTO-BIOLOGICAL REACTIONS AND GRAVITATIONAL AND OTHER AMBIENT ENERGY SOURCES TO SUBSTANTIVELY REPLACE MECHANICAL PROCESSES AND CHEMICAL INTERVENTION

(71) Applicant: VRM International Pty Ltd, Garbutt (AU)

(72) Inventor: Kenneth Michael Bellamy, Garbutt (AU)

(21) Appl. No.: 19/200,805

(22) Filed: May 7, 2025

(51) Int. Cl. C02F 3/34

(52) U.S. Cl. CPC C02F 3/348; C02F 2203/006; C02F 2301/024; C02F 2305/06

(57) ABSTRACT

A vessel for the treatment of wastewater includes first and second arcuate portions configured to receive the wastewater. A wastewater inlet and a dosing device are located at or adjacent a first end of the first arcuate portion, and the dosing device introduces one or more reagents into the wastewater, the reagents being configured to foster biological activity of one or more biological agents in the wastewater. The first and second arcuate portions are oriented relative to one another such that the vessel is substantially ring-shaped, and a second end of the first arcuate portion is spaced apart from a first end of the second arcuate portion by a weir portion. The vessel further includes a water outlet located at or adjacent a second end of the second arcuate portion, and the first and second arcuate portions and the weir portion are configured to generate turbulent conditions in the wastewater.

### TECHNICAL FIELD

The present invention relates to an apparatus and method for the treatment of wastewater. In particular, the present invention relates to an apparatus and method for the treatment of wastewater by the removal of contaminants using a combination of biological reactions and turbulent conditions in the wastewater, enhanced by solar radiation and/or one or more other ambient energy sources. More specifically, the present invention relates to an apparatus and method for the treatment of wastewater by the removal of contaminants using a combination of mechanisms which make use of solar radiation and/or one or more reagents to stimulate biological agents in the wastewater and to create turbulent conditions in the wastewater leading to a reaction which removes contaminants.

### BACKGROUND

Wastewater treatment is a process which removes contaminants from wastewater, resulting in an effluent having an acceptable impact on the environment such that the effluent can be returned to the water cycle.

Typically, wastewater treatment plants comprise multiple stages of wastewater treatment including mechanical, biological and chemical processes, resulting in significant capital, maintenance and operational costs. Such processes often generate unpleasant odours resulting from the type and number of processes.

Thus, there would be an advantage if it were possible to provide a method and apparatus for the treatment of wastewater that could provide effective wastewater treatment while also reducing capital and operational costs. Further, there would be an advantage if it were possible to provide treated wastewater of consistent quality, particularly in terms of reducing or eliminating odour production, thereby reducing the need for chemical and mechanical intervention and stabilising biological reactions. Still further, there would be an advantage if it were possible to provide a wastewater treatment process with minimal maintenance requirements and which is able to remove heavy metal and pathogenic contaminants from the wastewater without the need for specific chemical or mechanical intervention.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a method and vessel for the treatment of wastewater, which may at least partially address one or more of the problems or deficiencies mentioned above or which may provide the public with a useful or commercial choice.

With the foregoing in view, the present invention in one form, resides broadly in a vessel for the treatment of wastewater, the vessel comprising:
A first arcuate portion configured to receive the wastewater;
A second arcuate portion configured to receive the wastewater,
A wastewater inlet located at or adjacent a first end of the first arcuate portion; and
A dosing device located at or adjacent a first end of the first arcuate portion, the dosing point configured to introduce one or more reagents into the wastewater, the one or more reagents being configured to foster biological activity of one or more biological agents in the wastewater,
Wherein the first arcuate portion and the second arcuate portion are oriented relative to one another such that the vessel is substantially ring-shaped, and
Wherein a second end of the first arcuate portion is spaced apart from a first end of the second arcuate portion by a weir portion,
The vessel further comprising a water outlet located at or adjacent a second end of the second arcuate portion, and
Wherein the first arcuate portion, the second arcuate portion and the weir portion are configured to generate turbulent conditions in the wastewater, the turbulent conditions being conducive to fostering the biological activity of the one or more biological agents, thereby contributing to removal of contaminants from the wastewater by the one or more biological agents.

The first arcuate portion and the second arcuate portion may be of any suitable size or configuration. In a preferred embodiment, the first arcuate portion and the second arcuate portion may each comprise a base, an inner radius wall and an outer radius wall. Preferably, the inner radius wall and the outer radius wall are connected to each other via an end wall located at each opposed end of the first arcuate portion and the second arcuate portion.

It is envisaged that the end walls of the first arcuate portion and the second arcuate portion are located adjacent the weir portion. More particularly, it is envisaged that an end wall at the second end of the first arcuate portion and an end wall at the first end of the second arcuate portion may be located adjacent the weir portion. In a preferred embodiment, the end wall at the second end of the first arcuate portion and the end wall at the first end of the second arcuate portion may form at least a portion of the weir portion.

The base may be of any suitable size or configuration. It is envisaged that the base may extend between the inner radius wall and the outer radius wall, and between the end walls located at opposed ends of the arcuate portions. Thus, the base may be substantially arcuate in shape.

The base may be fabricated from any suitable material. For instance, the base all may be fabricated from a metallic material, a polymeric material, a ceramic material, a cementitious material (such as concrete), glass, wood, fibreglass or the like, or any suitable combination thereof. In some embodiments, the base may comprise a ground surface. In these embodiments, the ground surface may be prepared for use as the base using any suitable technique. For instance, the ground surface may be compacted. Alternatively, the ground surface may be coated or otherwise covered, such as with a waterproofing composition, membrane or the like.

The base may be of unitary construction. Alternatively, the base may be fabricated from two or more base portions configured for connection to one another. In these embodiments, the base portions may be configured for fixed connection to one another (such as by processes such as welding, brazing or the like). Alternatively, the base portions may be configured for removable connection to one another (such as via one or more connection members, fasteners or the like). In this way, the base may be deconstructed and moved to a new location as required, or portions of the base may be disconnected for repair or replacement if needed.

In a preferred embodiment of the invention the base may be substantially planar. In some embodiments of the invention, the base may slope along at least a portion of its dimensions. For instance, the base may slope (preferably, downwardly) between the inner radius wall and the outer radius wall. Alternatively, the base may slope (preferably, upwardly) between a first end wall and an opposed second end wall of at least one of the first arcuate portion and the second arcuate portion.

In a preferred embodiment, the wastewater may flow in a direction between a first end and an opposed second end of each arcuate portion. In this embodiment, it is envisaged that the depth (and specifically, the water holding depth) of the arcuate portion at the first end thereof may be greater than the depth of the arcuate portion at the opposed second end.

The inner radius wall may be of any suitable size or configuration. Preferably, the inner radius wall may be substantially arcuate in plan view. It is envisaged that the inner radius wall is located at the inner periphery of the base, such that an inner periphery of the base meets a lower end of the inner radius wall.

The inner radius wall may be fabricated from any suitable material. For instance, the inner radius wall may be fabricated from a metallic material, a polymeric material, a ceramic material, a cementitious material (such as concrete), glass, wood, fibreglass or the like, or any suitable combination thereof. In some embodiments, the inner radius wall may comprise an earthen material. Any suitable earthen material may be used, such as, but not limited to, cob, mud brick, rammed earth or the like. The inner radius wall may be prepared for use using any suitable technique. For instance, the inner radius wall may be coated or otherwise covered, such as with a waterproofing composition, membrane or the like.

The inner radius wall may be of unitary construction. Alternatively, the inner radius wall may be fabricated from two or more inner radius wall portions configured for connection to one another. In these embodiments, the inner radius wall portions may be configured for fixed connection to one another (such as by processes such as welding, brazing or the like). Alternatively, the inner radius wall portions may be configured for removable connection to one another (such as via one or more connection members, fasteners or the like). In this way, the inner radius wall may be deconstructed and moved to a new location as required, or portions of the inner radius wall may be disconnected for repair or replacement if needed.

As previously stated, the base may meet the lower end of the inner radius wall at the inner periphery of the base. Any suitable angle may be formed between the lower end of the inner radius wall and the base. In a preferred embodiment of the invention, however, the angle between the lower end of the inner radius wall and the base may be such that the upper end of the inner radius wall is angled outwardly away from the outer radius wall. Thus, the angle between the lower end of the inner radius wall and the base may be greater than 90°. More preferably, the angle between the lower end of the inner radius wall and the base may be between 90° and 160°. More preferably, the angle between the lower end of the inner radius wall and the base may be between 100° and 150°. More preferably, the angle between the lower end of the inner radius wall and the base may be between 110° and 140°.

The outer radius wall may be of any suitable size or configuration. Preferably, the outer radius wall may be substantially arcuate in plan view. It is envisaged that the outer radius wall is located at the outer periphery of the base, such that an outer periphery of the base meets a lower end of the outer radius wall.

The outer radius wall may be fabricated from any suitable material. For instance, the outer radius wall may be fabricated from a metallic material, a polymeric material, a ceramic material, a cementitious material (such as concrete), glass, wood, fibreglass or the like, or any suitable combination thereof. In some embodiments, the outer radius wall may comprise an earthen material. Any suitable earthen material may be used, such as, but not limited to, cob, mud brick, rammed earth or the like. The outer radius wall may be prepared for use using any suitable technique. For instance, the outer radius wall may be coated or otherwise covered, such as with a waterproofing composition, membrane or the like.

The outer radius wall may be of unitary construction. Alternatively, the outer radius wall may be fabricated from two or more outer radius wall portions configured for connection to one another. In these embodiments, the outer radius wall portions may be configured for fixed connection to one another (such as by processes such as welding, brazing or the like). Alternatively, the outer radius wall portions may be configured for removable connection to one another (such as via one or more connection members, fasteners or the like). In this way, the outer radius wall may be deconstructed and moved to a new location as required, or portions of the outer radius wall may be disconnected for repair or replacement if needed.

As previously stated, the base may meet the lower end of the outer radius wall at the outer periphery of the base. Any suitable angle may be formed between the lower end of the outer radius wall and the base. In a preferred embodiment of the invention, however, the angle between the lower end of the outer radius wall and the base may be such that the upper end of the outer radius wall is angled outwardly away from the inner radius wall. Thus, the angle between the lower end of the outer radius wall and the base may be greater than 90°. More preferably, the angle between the lower end of the outer radius wall and the base may be between 90° and 170°. More preferably, the angle between the lower end of the outer radius wall and the base may be between 110° and 160°. More preferably, the angle between the lower end of the outer radius wall and the base may be between 130° and 150°.

The end walls may be of any suitable size or configuration. Preferably, the end walls may be substantially linear in plan view. It is envisaged that the end walls may be located at opposed ends of the base, such that an end of the base meets a lower end of the end walls.

The end walls may be fabricated from any suitable material. For instance, the end walls may be fabricated from a metallic material, a polymeric material, a ceramic material, a cementitious material (such as concrete), glass, wood, fibreglass or the like, or any suitable combination thereof. In some embodiments, the end walls may comprise an earthen material. Any suitable earthen material may be used, such as, but not limited to, cob, mud brick, rammed earth or the like. The end walls may be prepared for use using any suitable technique. For instance, the end walls may be coated or otherwise covered, such as with a waterproofing composition, membrane or the like.

The end walls may be of unitary construction. Alternatively, the end walls may be fabricated from two or more end wall portions configured for connection to one another. In these embodiments, the end wall portions may be configured for fixed connection to one another (such as by processes such as welding, brazing or the like). Alternatively, the end wall portions may be configured for removable connection to one another (such as via one or more connection members, fasteners or the like). In this way, the end walls may be deconstructed and moved to a new location as required, or portions of the end walls may be disconnected for repair or replacement if needed.

As previously stated, the base may meet the lower end of the end walls at the end of the base. Any suitable angle may be formed between the lower end of the end walls and the base. In a preferred embodiment of the invention, however, the angle between the lower end of the end walls and the base may be such that the upper end of the end walls is angled outwardly away from the base. Thus, the angle between the lower end of the end walls and the base may be greater than 90°. More preferably, the angle between the lower end of the outer radius wall and the base may be between 90° and 160°. More preferably, the angle between the lower end of the outer radius wall and the base may be between 100° and 150°. More preferably, the angle between the lower end of the outer radius wall and the base may be between 110° and 140°.

The inner radius wall, the outer radius wall and/or the end walls may extend in a linear manner between the lower ends and upper ends thereof. In this embodiment of the invention, the first arcuate portion and the second arcuate portion may have an inverted trapezoid shape in cross-section.

In some embodiments, the inner radius wall, the outer radius wall and/or the end walls may be curved between the lower ends and upper ends thereof.

The weir portion may be of any suitable size, shape or configuration. The weir portion and the wastewater outlet may be spaced apart from one another at any suitable point about the ring-shaped vessel. Preferably, however, the weir portion and the wastewater outlet may be spaced approximately 180° apart from one another about the ring-shaped vessel. In this embodiment, it is envisaged that the first arcuate portion and the second arcuate portion are substantially the same size as one another, in both surface area and volume.

In some embodiments of the invention, one or more protrusions may be located on the base of the first arcuate portion and/or the second arcuate portion. Any suitable protrusions may be provided, although in a preferred embodiment of the invention it is envisaged that the one or more protrusions may be configured to generate turbulent conditions in the wastewater in the first arcuate portion and/or the second arcuate portion.

The one or more protrusions may be of any suitable size, shape or configuration. For instance, the one or more protrusions may be in the form of baffles, reefs, channels, or the like or any suitable combination thereof. In a preferred embodiment, the one or more protrusions extend at least partway across the arcuate portion between the inner radius wall and the outer radius wall. In some embodiments, the one or more protrusions may extend substantially the entire distance between the inner radius wall and the outer radius wall.

In a preferred embodiment, the one or more protrusions comprises an elongate raised portion that extends across the base. In particular, the one or more protrusions comprises an elongate raised portion that extends substantially the entire distance across the base between the inner radius wall and the outer radius wall. The elongate raised portion may be of unitary construction or may comprise a plurality of portions connected to one another or in abutment with one another. The elongate raised portion may extend in a substantially straight line between the inner radius wall and the outer radius wall, or may follow a torturous path between the inner radius wall and the outer radius wall. In some embodiments of the invention, the elongate raised portion may be substantially S-shaped in plan view. In a preferred embodiment, the tail of the S-shaped elongate raised portion may be located at or adjacent the outer radius wall.

It is envisaged that each arcuate portion may be provided with a plurality of elongate raised portions. Each of the plurality of elongate raised portions may be spaced apart from one another by any suitable distance.

The first arcuate portion and the second arcuate portion may be of any suitable depth. However, in a preferred embodiment of the invention, the arcuate portions are at least 2 metres in depth.

The first arcuate portion and the second arcuate portion may have any suitable ratio of surface area to volume. Preferably, however, the ratio of surface area to volume in the first arcuate portion and the second arcuate portion may be between approximately 0.1 m⁻¹ and 0.8 m⁻¹. More preferably, the ratio of surface area to volume in the first arcuate portion and the second arcuate portion may be between approximately 0.15 m⁻¹ and 0.6 m⁻¹. More preferably, the ratio of surface area to volume in the first arcuate portion and the second arcuate portion may be between approximately 0.2 m⁻¹ and 0.4 m⁻¹. Most preferably, the ratio of surface area to volume in the first arcuate portion and the second arcuate portion may be approximately 0.25 m⁻¹.

The weir portion may be configured to serve any suitable purpose. For instance, the weir portion may serve as a barrier to the flow of fluid between the first arcuate portion and the second arcuate portion. The weir portion may be configured to generate turbulence in the liquid in the vessel by providing an obstacle against which liquid flowing in the vessel impacts. In some embodiments, the weir portion may allow liquid impacting thereagainst to overflow the first arcuate portion along the weir portion into the second arcuate portion. The weir portion may be configured to provide a barrier to the movement of solid or particulate matter suspended in the wastewater between the first arcuate portion and the second arcuate portion but to allow a flow of liquid between the first arcuate portion and the second arcuate portion. In this way, the movement of organic or other contaminants from the first arcuate portion to the second arcuate portion may be reduced or eliminated. Thus, the weir portion may be configured to generate turbulence in the liquid in the vessel, while also reducing the transfer of contaminants between the arcuate portions and reducing the rate of flow of liquid between the arcuate portions.

The weir portion may be fabricated from any suitable material. For instance, the weir portion may be fabricated from a metallic material, a polymeric material, a ceramic material, a cementitious material (such as concrete), glass, wood, fibreglass or the like, or any suitable combination thereof. In some embodiments, the weir portion may comprise an earthen material. Any suitable earthen material may be used, such as, but not limited to, cob, mud brick, rammed earth or the like. The weir portion may be prepared for use using any suitable technique. For instance, the weir portion may be coated or otherwise covered, such as with a waterproofing composition, membrane or the like.

The weir portion may be of unitary construction. Alternatively, the weir portion may be fabricated from two or more weir portion members configured for connection to one another. In these embodiments, the weir portion members may be configured for fixed connection to one another (such as by processes such as welding, brazing or the like). Alternatively, the weir portions members may be configured for removable connection to one another (such as via one or more connection members, fasteners or the like). In this way, the weir portion may be deconstructed and moved to a new location as required, or portions of the weir portion may be disconnected for repair or replacement if needed.

The base may meet the lower end of the weir portion at opposed ends of the base. Any suitable angle may be formed between the lower end of the weir portion and the base. In a preferred embodiment of the invention, however, the angle between the lower end of the weir portions and the base may be such that the upper end of the weir portion is angled outwardly towards the other arcuate portion. Thus, the angle between the lower end of weir portion and the base may be greater than 90°. More preferably, the angle between the lower end of the weir portion and the base may be between 90° and 170°. More preferably, the angle between the lower end of the weir portion and the base may be between 110° and 170°. More preferably, the angle between the lower end of the weir portion and the base may be between 130° and 150°.

The weir portion may space the first arcuate portion and the second arcuate portion apart from one another by any suitable distance, and it will be understood that the width of the weir portion (and therefore, the distance between the second end of the first arcuate portion and the first end of the second arcuate portion) may be dependent on the size (in terms of surface area, volume, diameter and the like) of the vessel, the degree of turbulence created in the vessel, the nature of the wastewater to be treated and so on.

In some embodiments, one or more wastewater passages may pass through the weir portion. In this embodiment, it is envisaged that the first arcuate portion and the second arcuate portion may be in fluid communication with one another via the one or more wastewater passages.

The wastewater passages may be of any suitable form and may consist of a conduit (such as a pipe, hose, or simply a bore through the weir portion) through which wastewater may flow between the second end of the first arcuate portion and the first end of the second arcuate portion. The wastewater may flow through the one or more wastewater passages through wave motion, tidal motion or the like. Alternatively, the wastewater may flow through the one or more wastewater passages via gravity. In other embodiments, wastewater may be pumped through the one or more wastewater passages.

Preferably, the one or more wastewater passages may be configured to allow the flow of liquid between the first arcuate portion and the second arcuate portion, but to reduce or eliminate the movement of solid matter between the first arcuate portion and the second arcuate portion. In some embodiments, one or more flow control members may be located on the wastewater passages. The one or more flow control members may include valves, gates or the like. In some embodiments, the valves may comprise one way valve to preclude or eliminate the flow of wastewater from the second arcuate portion to the first arcuate portion.

In some embodiments, the one or more wastewater passages may be provided with a separation device (such as a filter, screen, membrane or the like) to reduce or eliminate the flow of solid or particulate matter from the first arcuate portion to the second arcuate portion. The separation device may be located at any suitable location, although in some embodiments the separation device may be associated with an inlet end of the wastewater passages.

In a preferred embodiment of the invention, the vessel is uncovered. Preferably, the vessel is located outdoors. Preferably, the wastewater in the vessel may be exposed to natural light. In this way, it is envisaged that solar radiation may penetrate the surface of the wastewater in the vessel.

The wastewater may be of any suitable type. For instance, the wastewater may comprise greywater, blackwater, industrial wastewater, stormwater, agricultural wastewater, or any suitable combination thereof.

As previously stated, a wastewater inlet is located at or adjacent the first end of the first arcuate portion. The wastewater inlet may be of any suitable form and may comprise a conduit (such as a hose, pipe or the like), a gate, an overflow weir, a spillway or the like, or any suitable combination thereof. In some embodiments, a body of wastewater (such as a dam, stream, reservoir or the like) may be positioned adjacent the vessel, and wastewater may flow into the vessel directly from the body of wastewater. In other embodiments, the wastewater may be transferred (such as by pumping, gravity feed or the like) from another location to the vessel. In further embodiments, the wastewater may be shipped to the vessel in a vehicle (such as a water tanker or the like).

In a preferred embodiment, the wastewater inlet may be provided with a flow adjustment member configured to adjust the flow of wastewater into the vessel. Any suitable flow adjustment member may be provided, such as, but not limited to, one or more valves, gates or the like. The one or more flow adjustment members may be actuated to increase or decrease the flow of wastewater into the vessel as required.

A dosing device is located at or adjacent the first end of the first arcuate portion. The dosing device may be of any suitable form. For instance, the dosing device may comprise one or more spray heads, nozzles, irrigation devices, manifolds, water cannons, hoses, or the like or any suitable combination thereof. As stated previously, the dosing device may be configured to introduce one or more reagents into the wastewater. Thus, it is envisaged that the dosing device may be in fluid communication with a source of the reagent.

The source of the reagent may be of any suitable form. In a preferred embodiment, the source of the reagent may comprise a receptacle. The receptacle may be of any suitable form, such as a tank, reactor, pond, bunded area, container or the like. The reagent may be transferred from the receptacle to the dosing device using any suitable technique. For instance, the reagent may be pumped or gravity fed from the receptacle to the dosing device.

The dosing device may introduce the reagent into the wastewater in the first arcuate portion (and, in particular, into the wastewater at or adjacent the first end of the first arcuate portion) and/or into the wastewater inlet.

In some embodiments, one or more additional dosing devices may be provided. In a preferred embodiment of the invention, an additional dosing device may be configured to introduce a reagent to the first arcuate portion.

In another embodiment, an additional dosing device may be configured to introduce a reagent to the second arcuate portion. The additional dosing device may introduce a reagent to any suitable part of the second arcuate portion. In a preferred embodiment, the additional dosing device may introduce a reagent into the wastewater at or adjacent a first end of the second arcuate portion.

In a specific embodiment, a first additional dosage device may be configured to introduce a reagent to the first arcuate portion, while a second additional dosage device may be configured to introduce a reagent to the second arcuate portion. In a preferred embodiment, the same reagent may be introduced through each of the dosing devices.

In another embodiment, it is envisaged that three dosing devices may be associated with the vessel. The dosing devices may be located at any suitable location relative to the vessel. However, in a particular embodiment, a first dosing device may be located at or adjacent a first end of the first arcuate portion (and preferably associated with the wastewater inlet), a second dosing device may be located between opposed ends of the first arcuate portion, and a third dosing device may be located at or adjacent a first end of the second arcuate portion. It is envisaged that the location of the third dosing device may depend on the nature of the reagents to be introduced to the wastewater, the nature and composition of the wastewater (and the contaminants contained therein) the size of the vessel and so on.

In a preferred embodiment of the invention, the third dosing device may be configured to deliver the one or more reagents onto the surface of the wastewater in the first arcuate portion or the second arcuate portion.

The reagent introduced to the wastewater may be of any suitable form. In some embodiments of the invention, the reagent may be configured to remove contaminants from the wastewater. The removal of contaminants from the wastewater by the reagent may occur in any suitable manner. For instance, the reagent may be configured to consume, digest, dissipate or otherwise break down contaminants in the wastewater. The contaminants may be of any suitable form, such as pollutants (chemicals and the like) and/or organic material. In some embodiments, the contaminants may include heavy metals, pathogens (such as viruses) and so on. It will be understood that the exact nature of the contaminants may be dependent on the source of the wastewater.

In addition, or as an alternative, to acting directly on contaminants in the wastewater, the reagent may be configured to stimulate or catalyse one or more reactions (chemical and/or biological) within the wastewater that result in the removal of contaminants therefrom. In these embodiments, it is envisaged that the wastewater may contain one or more biological agents. The one or more biological agents may occur naturally in the wastewater, or may be introduced thereto. In embodiments of the invention in which the one or more biological agents are introduced to the wastewater, it is envisaged that this may occur at any suitable time. However, in a preferred embodiment, the one or more biological agents may be introduced to the wastewater just prior to, or as, the wastewater is introduced to the vessel (e.g., in the wastewater inlet).

It is envisaged that the reagent and the biological agents come into contact with one another in the vessel and, more specifically, in the first arcuate portion. However, it will be understood that the reagent and the biological agents come into contact with one another at each location where a dosing device is provided.

In a preferred embodiment, the reagent may be configured to stimulate biological reactions in the biological agents which consume at least a portion of the contaminants (including chemical and/or organic contaminants) in the wastewater. In some embodiments, the reagent may be configured to stimulate biological activity in the biological agents which may prevent the generation of and/or consume gases. Preferably the gases included gases that generate odour such as, but not limited to, hydrogen sulphide. Thus, it is envisaged that odours generated by the wastewater treated in the vessel may be reduced or eliminated.

In some embodiments, the populations of the biological agents may be maintained in the wastewater. In particular, effective populations (i.e., to effectively removed contaminants from the wastewater) of the biological agents may be maintained. This may be achieved using any suitable technique, such as, but not limited to, adding additional biological agents to the wastewater at one or more points in the vessel. In other embodiments, nutrients upon which the biological agents feed may be added to the vessel.

The biological agents may be of any suitable form. For instance, the biological agents may include yeasts, algae, cyanobacteria or the like. In a preferred embodiment, the biological agents may comprise heterotrophic biological agents and, in particular, photosynthetic heterotrophic biological agents. Any suitable heterotrophic biological agents may be used, including aerobic, anaerobic or facultative bacteria. The heterotrophic biological agents may comprise Acinetobacter, Alcaligenes, Brevibacterium, Caulobacter, Comomonas, Cytophaga, Flavobacterium, Hyphomicrobium, Microbacterium, Pseudomonas, Sphaerotilus and the like, or any suitable combination thereof.

In a specific embodiment, the biological agents may include purple nonsulphur producing heterotrophic photosynthetic bacteria, lactobacillus, yeasts, actinomycetes, Nocardia species, ray fungi, plankton and other chemoautotrophic bacteria.

In a preferred embodiment, the shape and configuration of the vessel may create a flow pattern in the wastewater in the vessel. For instance, it is envisaged that the velocity of the flow of wastewater in regions adjacent the outer radius wall and/or the inner radius wall may be greater than the velocity of wastewater flowing in the vessel at a point intermediate the inner radius wall and the outer radius wall. It is envisaged that, particularly in windy conditions, this difference in velocity within the body of wastewater may create turbulence. In some embodiments, the difference in velocity within the body of wastewater may create a wave motion within the wastewater. It is envisaged that the waves may travel along the length of each of the arcuate portions. In this way, relatively continuous turbulent motion may be created within the wastewater

In some embodiments, the diameter of the vessel (i.e., the diameter formed by the first arcuate portion and the second arcuate portion) and the mass of the wastewater contained within the vessel may be of sufficient size that the wastewater is affected by gravitational energy. In this embodiment, it is envisaged that wastewater within the vessel may behave in a tidal manner. It is envisaged that tidal movement in the wastewater may result in the creation of kinetic energy within the wastewater which may contribute to the mixing of the reagent and the biological agents, and/or the generation of turbulent conditions in the wastewater.

Preferably, biological activity stimulated by the reagent within the wastewater may enhance biological reactions which are impacted by the action of gravity and/or the influence of turbulence. For instance, reactions which result in bioluminescence may be enhanced by the biological activity stimulated by the reagent.

The one or more reagents may be of any suitable form. Generally, the one or more reagents may comprise a source of, and/or a substrate produced by, and which stimulates the activity of, one or more prokaryotic organisms. For instance, the one or more reagents may provide a substrate which stimulates the activity of one or more species of Archaea, one or more species of bacteria, or any suitable combination thereof. The prokaryotic organism may be anaerobic, aerobic, autotrophic, heterotrophic, phototrophic, chemotrophic, photosynthetic, or any suitable combination thereof.

Generally, the one or more reagents may provide a substrate which may stimulate the activity of low temperature fermentation microorganisms. As used herein, low temperature fermentation microorganisms refer to microorganisms at which the optimum conditions for fermentation occurs at temperatures of below 30 °C, more preferably below 28 °C, more preferably below 25 °C and more preferably below 20 °C. In a preferred embodiment of the invention, the one or more reagents may comprise a humified soil prepared from the continuous fermentation of an organic material. In an embodiment of the invention, the one or more reagents may comprise a humified soil prepared from the continuous fermentation of an organic material, wherein the continuous fermentation comprises a source of and provides a habitat for the sustained activity of low temperature fermentation microorganisms. In a preferred embodiment of the invention, the one or more reagents may comprise a humified soil prepared from the continuous fermentation of an organic material, wherein the humified soil comprises a viable source of and/or substrates produced by and which stimulate the activity of at least one of an aerobic microorganism, an anaerobic microorganism and a photosynthetic microorganism. Preferably, the one or more reagents may comprise a humified soil prepared from the fermentation of an organic material, wherein the humified soil comprises a source of and/or substrates produced by, and which stimulate the activity of heterotrophic photosynthetic bacteria and/or prokaryotic organisms including either one of Archaea or bacteria. In an embodiment of the invention, the one or more reagents may be an output product produced by the method and/or system described in Australian patent no. 2014250680, the disclosure of which is incorporated herein by reference. In some embodiments, the one or more reagents may stimulate the activity of at least one of an aerobic microorganism, an anaerobic microorganism, and a photosynthetic microorganism. Preferably, the one or more reagents may stimulate the activity of a heterotrophic photosynthetic bacteria and/or prokaryotic organism including either one of Archaea or bacteria.

In other embodiments of the invention, the one or more reagents may comprise a liquid fertiliser or biological substrate. In a preferred embodiment of the invention, the one or more reagents may comprise a liquid fertiliser or biological substrate prepared from the continuous fermentation of an organic material. In an embodiment of the invention, the one or more reagents may comprise a liquid fertiliser or biological substrate prepared from the continuous fermentation of an organic material, wherein the liquid fertiliser or biological substrate may be a reconstituted microbial substrate. In an embodiment of the invention, the one or more reagents may comprise a liquid fertiliser or biological substrate prepared from the continuous fermentation of an organic material, wherein the continuous fermentation comprises a source and a habitat for the activity of low temperature fermentation microorganisms. In a preferred embodiment of the invention, the one or more reagents may comprise a liquid fertiliser or biological substrate prepared from the continuous fermentation of an organic material, wherein the liquid fertiliser or biological substrate comprises a viable source of and/or substrates produced by and which stimulate the activity of at least one of an aerobic microorganism, an anaerobic microorganism, a heterotrophic microorganism and a photosynthetic microorganism. Preferably, the one or more reagents may comprise a liquid fertiliser or biological substrate prepared from the continuous fermentation of an organic material, wherein the liquid fertiliser or biological substrate comprises a source of and/or substrates produced by and which stimulate the activity of heterotrophic photosynthetic bacteria and/or prokaryotic organisms including either one of Archaea or bacteria. In an embodiment of the invention, the one or more reagents may be an output product produced by the method and/or system described in Australian patent no. 2012283757, the disclosure of which is incorporated herein by reference.

In some embodiments, the one or more reagents may stimulate the activity of one or more prokaryotic organisms, such as heterotrophic photosynthetic bacteria, lactobacillus species, yeasts, actinomycetes species, Nocardia species, ray fungi, plankton, chemotrophic bacteria, or any suitable combination thereof.

In some embodiments, the one or more reagents may comprise a liquor, a fertiliser (and particularly a biofertilizer) or other high value organic material, a humus or humified soil, an incubated culture, a collected substrate for energy generation, or the like.

It is envisaged that the wastewater within the vessel may flow between opposed ends of each of the first arcuate portion and the second arcuate portion. Thus, it is envisaged that the flow of wastewater between the inner radius wall and the outer radius wall is minimised and that the motion of water within each arcuate portion is substantively longitudinal (i.e., between opposed ends of the arcuate portions) and vertical (i.e., between the base and the surface of the wastewater) within the arcuate portions. It is envisioned that the meeting of counter currents created by the longitudinal flow may create sites within the vessel at which whirlpools may form. In this embodiment, it is envisaged that the formation of whirlpools may enhance both biological activity and mixing within the wastewater. Preferably, the mixing may be relatively homogeneous within the wastewater in the vessel.

It is envisaged that the relatively homogenous mixing effect described above may result in movement of the wastewater in the vessel to the surface. In this embodiment, wastewater at the surface of the vessel may be exposed to atmospheric oxygen and/or solar radiation, which may stimulate the biological reactions within the wastewater (particularly for photosynthetic biological agents and algae).

In some embodiments, the biological activity that occur in the wastewater may include fermentation reactions, reactions that harvest hydrogen ions and/or reactions that create one or more chemical substances that enhance the removal of contaminants from the wastewater. In a specific example, it is envisaged that, as a by-product of the biological activity of lactobacillus in the wastewater, hydrogen peroxide may form in the wastewater. Hydrogen peroxide may assist in breaking down organic particles in the wastewater.

Further, it is envisaged that the homogenous mixing effect created by the shape and water movement within the arcuate portions may allow for contact between wastewater containing hydrogen peroxide and radiation from sunlight. In these embodiments, it is envisaged that hydrogen peroxide may be at least partially converted to a hydroxyl radical capable of oxidation of organic particles.

It is envisaged that the angle created between the base and lower portions of the inner radius wall, outer radius wall, first wall portion and/or second wall portion may create turbulence within the wastewater.

It is envisaged that the shape of the first arcuate portion and the second arcuate portion may create a counter current in the wastewater. In some embodiments, wastewater in a lower region of the vessel may flow in a different direction to wastewater in an upper region of the vessel.

In a preferred embodiment of the invention, the turbulent conditions created in the wastewater due to the shape of the vessel may foster the growth of the biological agents within the wastewater. The growth of the biological agents within the wastewater may result in more effective and/or more efficient removal of contaminants from the wastewater by the biological agents grown. Thus, advantageously, the shape and configuration of the vessel may be conducive to conditions that result in the more effective and/or more efficient removal of contaminants from the wastewater. In particular, the present invention may result in the rapid formation of an activated sludge comprising communities of biological agents that remove contaminants from the wastewater.

As previously stated, the vessel is substantially ring-shaped, meaning that a central region may be formed that is at least partially surrounded by the inner radius wall of the first arcuate portion and the inner radius wall of the second arcuate portion.

The central region may be of any suitable size, and the size of the central region may be determined by the size of the arcuate portions. It is envisaged that the central region may be substantially circular in shape.

It is envisaged that the removal of contaminants from the wastewater by the biological agents may result in the formation of an output product. The output product may be of any suitable form. However, in some embodiments of the invention, it is envisaged that the output product may comprise a water product. Preferably, the output product may include water and one or more output biological agents. In particular, the one or more output biological agents may be configured assist in the formation of an arable soil. Thus, it is envisaged that the output product may be suitable for irrigation. The one or more output biological products may comprise an agent configured to act in soil to produce a humus or humified soil. The agent may be of any suitable form. Preferably, the agent comprises a microorganism, such as, but not limited to, bacteria or fungi. The agent may comprise any suitable microorganism, such as, but not limited to actinomyces (including Streptomycets), Aspergillus, Pisolithus and/or Rhizoctonia.

The output product may be removed from the vessel in any suitable manner. Preferably, however, the output product may be removed from the vessel through the water outlet. The water outlet may be of any suitable form and may comprise a conduit (such as a hose, pipe or the like), a gate, an overflow weir, a spillway or the like, or any suitable combination thereof. In some embodiments, a body of the water product (such as a dam, stream, reservoir or the like) may be positioned adjacent the vessel, and the output product may flow out of the vessel through the water outlet into the body of water product. In other embodiments, the output product may be transferred (such as by pumping, gravity feed or the like) to another location remote to the vessel. In further embodiments, the output product may be shipped away from the vessel in a vehicle (such as a water tanker or the like).

In a preferred embodiment, the water outlet may be provided with a flow adjustment member configured to adjust the flow of the water product out of the vessel. Any suitable flow adjustment member may be provided, such as, but not limited to, one or more valves, gates or the like. The one or more flow adjustment members may be actuated to increase or decrease the flow of the water product out of the vessel as required.

In a preferred embodiment of the invention, the vessel may be located in an arid or semi-arid location. In this way, the present invention may be used to foster the creation of arable land in arid or semi-arid regions.

The vessel may be of any suitable outer diameter, and it will be understood that the outer diameter of the vessel may be dependent on the nature and quantity of the wastewater to be treated. For instance, the ring-shaped vessel may be greater than 10 metres in outer diameter. Preferably, the ring-shaped vessel may be greater than 50 metres in outer diameter. Preferably, the ring-shaped vessel may be greater than 100 metres in outer diameter. Preferably, the ring-shaped vessel may be greater than 250 metres in outer diameter. Preferably, the ring-shaped vessel may be greater than 500 metres in outer diameter. Preferably, the ring-shaped vessel may be greater than 750 metres in outer diameter. Preferably, the ring-shaped vessel may be about 1000 metres in outer diameter.

It will be understood that the term “outer diameter” refers to the distance from the centre of the ring-shape defined by the first arcuate portion and the second arcuate portion and the outer wall of the first arcuate portion and the second arcuate portion.

The vessel may be of any suitable inner diameter, and it will be understood that the outer diameter of the vessel may be at least partially dependent on the outer diameter of the vessel, although it will be understood that the inner diameter of the vessel will be smaller than that of the outer diameter of the vessel. In general, the inner diameter of the vessel may be between 1 metre and 100 metres less than the outer diameter of the vessel.

The wastewater may have any suitable residence time in the vessel, and it will be understood that the residence time in the vessel may depend on the nature and quantity of wastewater to be treated. For instance, the residence time of wastewater in the vessel may be greater than 1 hour. Preferably, the residence time of wastewater in the vessel may be greater than 12 hours. Preferably, the residence time of wastewater in the vessel may be greater than 24 hours. Preferably, the residence time of wastewater in the vessel may be greater than 3 days. Preferably, the residence time of wastewater in the vessel may be greater than 7 days. Preferably, the residence time of wastewater in the vessel may be greater than 14 days. Preferably, the residence time of wastewater in the vessel may be greater than 28 days. Preferably, the residence time of wastewater in the vessel may be greater about 45 days.

In a second aspect, the invention resides broadly in a method for removing contaminants from wastewater, the method comprising the steps of:
Providing a vessel for the treatment of wastewater, the vessel comprising a first arcuate portion, and a second arcuate portion, the first arcuate portion and the second arcuate portion being oriented relative to one another such that the vessel is substantially ring-shaped, and a second end of the first arcuate portion is spaced apart from a first end of the second arcuate portion by a weir portion, he vessel further comprising a water outlet located at or adjacent a second end of the second arcuate portion;
Introducing a reagent into the wastewater, the reagent being configured to remove contaminants from the wastewater and/or to stimulate or catalyse one or more reactions with one or more biological agents within the wastewater that result in the removal of contaminants therefrom; and
Generating turbulent conditions in the wastewater in the vessel, the turbulent conditions being conducive to fostering biological activity of the one or more biological agents, thereby contributing to removal of contaminants from the wastewater by the one or more biological agents.

In a preferred embodiment of the invention, the method may further comprise the step of generating an output product, the output product being in the form of a humified soil.

In a preferred embodiment of the invention, the output product may be transferred to a central region, the central region being at least partially surrounded by the inner radius wall of the first arcuate portion and the inner radius wall of the second arcuate portion.

### EXAMPLES

Wastewater was treated in a vessel as previously described using a method as described herein. A reagent in the form of a humified soil prepared from the fermentation of an organic material, wherein the humified soil comprises a source of and/or substrates produced by, and which stimulate the activity of heterotrophic photosynthetic bacteria and/or prokaryotic organisms including either one of Archaea or bacteria was introduced to the wastewater inlet via a first dosing device and to the first arcuate portion via a second dosing device. Samples of the wastewater were taken from the vessel at various locations as illustrated in FIG. 1.

The samples were tested to determine odour, biochemical oxygen demand, chemical oxygen demand as well as the presence of various contaminants within the wastewater at the various locations. The results of the tests are set out below.

Initial samples of the wastewater were taken before the wastewater was introduced to the vessel and at the wastewater inlet. Subsequent samples from within the first arcuate portion were taken 14 days after the initial samples.

TABLE 1
Odour

| | | | Surface | Surface | Surface | |
|---|---|---|---|---|---|---|
| | | | First End | Midpoint | Second | |
| | | | First | First | End First | |
| | | | Arcuate | Arcuate | Arcuate | % |
| | | Wastewater | Portion | Portion | Portion | Improvement |
| | Wastewater | Inlet (A1) | (A2) | (A3) | (A4) | over 14 days |
| H₂S ppm | 2.5 | 12 | 0 | 0 | 0 | 100 |
| NH₃ ppm | 0 | 3 | 0 | 0 | 0 | 100 |
| VOC ppm | 99.9 | 99.9 | 20 | 0 | 0 | 100 |

The results indicate complete removal of H₂S, NH₃ and VOC, all of which generate unpleasant odours in wastewater treatment. Thus, the present invention reduced or eliminates the generation of odours.

Biochemical Oxygen Demand (BOD) measures the amount of oxygen consumed by microorganisms when decomposing organic matter in water, while Chemical Oxygen Demand (COD) measures the amount of oxygen needed to chemically oxidize both organic and inorganic substances in water.

Initial samples of the wastewater were taken before the wastewater was introduced to the vessel and at the wastewater inlet. Subsequent samples from within the first arcuate portion were taken 14 days after the initial samples.

TABLE 2
Biochemical oxygen demand and chemical oxygen demand

| | | | Surface | Surface | Surface | |
|---|---|---|---|---|---|---|
| | | | First End | Midpoint | Second | |
| | | | First | First | End First | |
| | | | Arcuate | Arcuate | Arcuate | % |
| | | Wastewater | Portion | Portion | Portion | Improvement |
| | Wastewater | Inlet (A1) | (A2) | (A3) | (A4) | over 14 days |
| BOD | 100 | 100 | 100 | 100 | 60 | 40 |
| benchmark | | | | | | |
| COD | 110 | 100 | 100 | 30 | 30 | 72.73 |
| benchmark | | | | | | |

The results illustrate significant reductions in both BOD and COD, indicating the breakdown of organic matter in the wastewater through the action of the reagents.

Initial samples of the wastewater were taken before the wastewater was introduced to the vessel. Subsequent samples from within the first arcuate portion were taken 14 days after the initial samples.

TABLE 3
Contaminants

| | | Surface Second End First |
|---|---|---|
| | Wastewater | Arcuate Portion (A4) |
| Ammonia (mg/L) | 29.3 | 9.9 |
| Aluminium (mg/L) | 10.330 | 1.058 |
| Arsenic (mg/L) | 0.009 | <0.005 |
| Chromium (mg/L) | 0.124 | 0.041 |
| Copper (mg/L) | 0.037 | 0.008 |
| Iron (mg/L) | 6.559 | 0.195 |
| Lead (mg/L) | 0.005 | 0.002 |
| Manganese (mg/L) | 0.182 | 0.015 |
| Molybdenum (mg/L) | 0.014 | <0.005 |
| Nickel (mg/L) | 0.027 | <0.005 |
| Selenium (mg/L) | 0.007 | <0.005 |
| Vanadium (mg/L) | 0.097 | 0.005 |
| Zinc (mg/L) | 0.464 | 0.055 |
| Phosphorus (mg/L) | 12.15 | 9.00 |
| Fecal Coliforms | 10,700,000 | 19,000 |
| (CFU/100 mL) | | |
| Intestinal Eggs (per Litre) | 12 | <1.0 |
| E. coli (CFU/100 mL) | 300,000 | 5000 |
| Clostridium perfringens | 420 | 6 |
| (CFU/100 mL) | | |
| Floating particles (mg/L) | 3102 | <0.5 |
| Salmonella (MPN/100 mL) | 3200 | 60 |

The results indicate a significant reduction in the presence of heavy metals in the wastewater, along with reductions in bacteria and parasite levels.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a plan view of a vessel according to an embodiment of the present invention.

FIG. 2 illustrates a cross-sectional view of an arcuate portion of a vessel according to an embodiment of the present invention.

FIG. 3 illustrates a view of an arcuate portion of a vessel according to an embodiment of the present invention.

FIG. 4 illustrates a weir portion of a vessel according to an embodiment of the present invention.

FIG. 5 illustrates an isometric view of a vessel according to an embodiment of the present invention.

### DETAILED DESCRIPTION

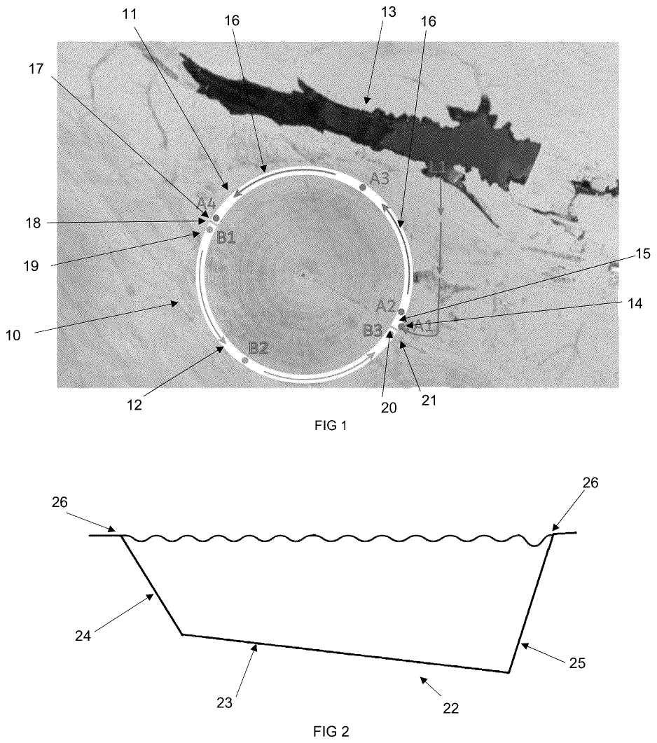

FIG. 1 illustrates a plan view of a vessel 10 according to an embodiment of the present invention. The vessel 10 comprises a first arcuate portion 11 and a second arcuate portion 12, the first arcuate portion 11 and the second arcuate portion 12 being oriented relative to one another such that the vessel 10 is ring-shaped.

Wastewater is received in the vessel 10 from a wastewater receptacle 13. In the embodiment of the invention shown in FIG. 1, the wastewater receptacle 13 is in the form of a dam.

Wastewater is pumped from the receptacle 13 to the vessel 10 and introduced to the first arcuate portion 11 through a wastewater inlet 14 located at a first end 15 of the first arcuate portion 11. A first reagent dosing point (not shown) is associated with the wastewater inlet 14, such that wastewater entering the first arcuate portion 11 has been contacted with reagent. In the embodiment of the invention shown in FIG. 1, the reagent comprises a humified soil prepared from the fermentation of an organic material, wherein the humified soil comprises a source of and/or substrates produced by, and which stimulate the activity of heterotrophic photosynthetic bacteria and/or prokaryotic organisms including either one of Archaea or bacteria.

Wastewater entering the vessel 10 flows along the first arcuate portion 11 in the direction of arrows 16, eventually reaching the second end 17 of the first arcuate portion 11. Wastewater may flow through one or more wastewater passages in a weir portion 18 separating the second end 17 of the first arcuate portion 11 and the first end 19 of the second arcuate portion 12. Wastewater then continues to flow along the second arcuate portion 12 to the second end 20 thereof, from which relatively clean water is removed through water outlet 21.

As well as the reagent dosing point associated with the wastewater inlet 14, two additional dosing points are provided. The first additional dosing point (not shown) is located at a point between the opposed first end 15 and second end 17 of the first arcuate portion 11, while a second additional dosing point (not shown) is located at or adjacent to the first end 19 of the second arcuate portion 12. The first additional dosing point and the second additional dosing point introduce the same reagent into the wastewater as the dosing point associated with the wastewater inlet 14.

In the embodiment of the invention shown in FIG. 1, the points A1, A2, A3 and A4 corresponding to the locations from which samples disclosed in Tables 1, 2 and 3 were taken from the vessel 10.

The wastewater contains contaminants in the form of one or more biological agents, metals (such as heavy metals), coliform bacteria, viruses and the like. At least a portion of the biological agents comprise heterotrophic biological agents, including aerobic, anaerobic or facultative bacteria. The reagent introduced to the vessel is configured to remove contaminants from the wastewater and/or to stimulate or catalyse one or more reactions with the one or more biological agents within the wastewater that result in the removal of contaminants therefrom

In the embodiment of the invention shown in FIG. 1, the first arcuate portion 11, the second arcuate portion 12 and the weir portion 18 are configured (together with wind, gravity and/or solar energy) to generate turbulent conditions in the wastewater in the vessel 10. The turbulent conditions are conducive to fostering the biological activity of the one or more biological agents, thereby contributing to removal of contaminants from the wastewater by the one or more biological agents.

FIG. 2 illustrates a cross-sectional view of an arcuate portion 22 of a vessel 10 according to an embodiment of the present invention. The arcuate portion may be either the first arcuate portion or the second arcuate portion.

In this Figure it may be seen that the arcuate portion 22 comprises a base 23, an inner radius wall 24 and an outer radius wall 25. The base 23 slopes downwardly from the inner radius wall 24 to the outer radius wall 25. Thus, the arcuate portion 22 is deeper adjacent to the outer radius wall 25 than the inner radius wall 24.

It is also shown in FIG. 2 that both the inner radius wall 24 and the outer radius wall 25 slope outwardly between the base 23 and upper regions 26 of the inner radius wall 24 and the outer radius wall 25.

The shape of the arcuate portion 22 as defined by the base 23, the inner radius wall and the outer radius wall 25 is configured (together with wind, gravity and/or solar energy) to generate turbulent conditions in the wastewater in the arcuate portion 22. In turn, the turbulent conditions are conducive to fostering the biological activity of the one or more biological agents in the wastewater, thereby contributing to removal of contaminants from the wastewater by the one or more biological agents.

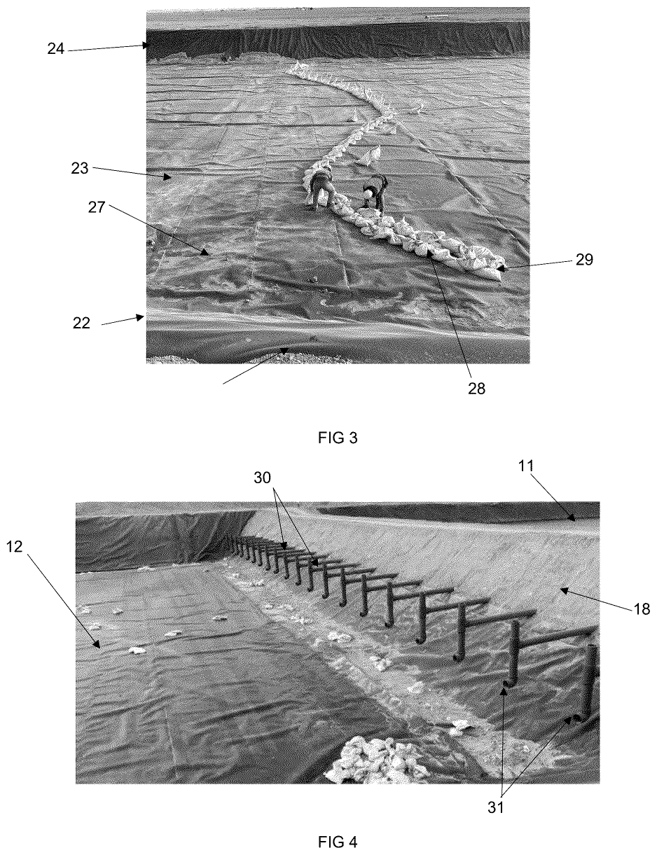

FIG. 3 illustrates a view of an arcuate portion 22 of a vessel according to an embodiment of the present invention. In this embodiment, it may be seen that the base 23, the inner radius wall 24 and the outer radius wall 25 are earthen and a polymer lining 27 is located within the arcuate portion 22 to provide a waterproof lining that substantially precludes seepage of wastewater into the surrounding area (or into groundwater).

Also in FIG. 3, an S-shaped elongate raised portion 28 may be seen on the base 23 of the arcuate portion 22. The elongate raised portion 28 is configured to increase turbulence within wastewater located in the arcuate portion 22. In the embodiment of the invention illustrated in this Figure, the elongate raised portion 28 is constructed from a plurality of sandbags 29 which are subsequently covered in a polymer lining to form the elongate raised portion 28.

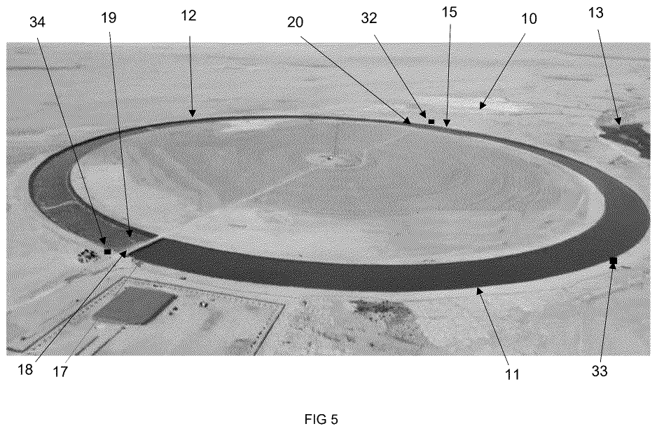

FIG. 4 illustrates a weir portion 18 of the vessel according to an embodiment of the present invention. In this embodiment, it may be seen that the weir portion 18 separates the first arcuate portion 11 from the second arcuate portion.

A plurality of wastewater passages 30 extend through the weir portion 18 such that the first arcuate portion 11 and the second arcuate portion 12 are in fluid communication with one another. The wastewater passages 30 comprise conduits that pass through the weir portion 18 and have an inlet (not shown) within the first arcuate portion 11 and an outlet 31 in the second arcuate portion 12.

It is envisaged that wastewater that reaches the second end of the first arcuate portion 11 through turbulent conditions created in the first arcuate portion will flow through the wastewater passages 30 and into the second arcuate portion 12.

FIG. 5 illustrates an isometric view of a vessel 10 according to an embodiment of the present invention. The vessel 10 comprises a first arcuate portion 11 and a second arcuate portion 12, the first arcuate portion 11 and the second arcuate portion 12 being oriented relative to one another such that the vessel 10 is ring-shaped.

Wastewater is received in the vessel 10 from a wastewater receptacle 13. In the embodiment of the invention shown in FIG. 1, the wastewater receptacle 13 is in the form of a dam.

Wastewater is pumped from the receptacle 13 to the vessel 10 and introduced to the first arcuate portion 11 through a wastewater inlet (obscured) located at a first end 15 of the first arcuate portion 11. A first reagent dosing point 32 is associated with the wastewater inlet, such that wastewater entering the first arcuate portion 11 has been contacted with reagent. In the embodiment of the invention shown in FIG. 5, the reagent comprises a humified soil prepared from the fermentation of an organic material, wherein the humified soil comprises a source of and/or substrates produced by, and which stimulate the activity of heterotrophic photosynthetic bacteria and/or prokaryotic organisms including either one of Archaea or bacteria.

Wastewater entering the vessel 10 flows along the first arcuate portion 11, eventually reaching the second end 17 of the first arcuate portion 11. Partway between the first end 15 and the second end 17 of the first arcuate portion 11, a second dosing point 33 introduces more reagent into the wastewater.

Wastewater that reaches the second end 17 of the first arcuate portion 11 flows through one or more wastewater passages (obscured) in a weir portion 18 separating the second end 17 of the first arcuate portion 11 and the first end 19 of the second arcuate portion 12. The wastewater passages (obscured) are configured to allow the flow of liquid therethrough, but to reduce or eliminate the flow of solid or particulate matter from the first arcuate portion 11 to the second arcuate portion 12. A third dosing point 34 is located at the first end 19 of the second arcuate portion, the third dosing point 34 configured to introduce more reagent into the wastewater.

Wastewater then continues to flow along the second arcuate portion 12 to the second end 20 thereof, from which relatively clean water is removed through the water outlet (obscured).

The wastewater contains contaminants in the form of one or more biological agents, metals (such as heavy metals), coliform bacteria, viruses and the like. At least a portion of the biological agents comprise heterotrophic biological agents, including aerobic, anaerobic or facultative bacteria. The reagent introduced to the vessel is configured to remove contaminants from the wastewater and/or to stimulate or catalyse one or more reactions with the one or more biological agents within the wastewater that result in the removal of contaminants therefrom

In the embodiment of the invention shown in FIG. 5, the first arcuate portion 11, the second arcuate portion 12 and the weir portion 18 are configured (together with wind, gravity and/or solar energy) to generate turbulent conditions in the wastewater in the vessel 10. The turbulent conditions are conducive to fostering the biological activity of the one or more biological agents, thereby contributing to removal of contaminants from the wastewater by the one or more biological agents.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A vessel for treatment of wastewater, the vessel comprising:
a first arcuate portion configured to receive the wastewater;
a second arcuate portion configured to receive the wastewater,
a wastewater inlet located at or adjacent a first end of the first arcuate portion; and
a dosing device located at or adjacent the first end of the first arcuate portion, the dosing device configured to introduce one or more reagents into the wastewater, the one or more reagents being configured to foster biological activity of one or more biological agents in the wastewater,
wherein the first arcuate portion and the second arcuate portion are oriented relative to one another such that the vessel is substantially ring-shaped, and
wherein a second end of the first arcuate portion is spaced apart from a first end of the second arcuate portion by a weir portion,
the vessel further comprising a water outlet located at or adjacent a second end of the second arcuate portion, and
wherein the first arcuate portion, the second arcuate portion and the weir portion are configured to generate turbulent conditions in the wastewater, the turbulent conditions being conducive to fostering the biological activity of the one or more biological agents, thereby contributing to removal of contaminants from the wastewater by the one or more biological agents.

2. The vessel according to claim 1, wherein the first arcuate portion and the second arcuate portion each comprise a base, an inner radius wall and an outer radius wall, the inner radius wall and the outer radius wall being connected to each other via an end wall located at each opposed end of the first arcuate portion and the second arcuate portion.

3. The vessel according to claim 2, wherein the end wall located at the second end of the first arcuate portion and the end wall at the first end of the second arcuate portion form at least a portion of the weir portion.

4. The vessel according to claim 2, wherein the base slopes between the inner radius wall and the outer radius wall of each of the first arcuate portion and the second arcuate portion.

5. The vessel according to claim 2, wherein an upper end of each of the inner radius walls is angled outwardly away from the outer radius walls, such that an angle between a lower end of the inner radius walls and the base is between 100° and 150°.

6. The vessel according to claim 2, wherein an upper end of each of the outer radius walls is angled outwardly away from the inner radius walls, such that an angle between a lower end of the outer radius walls and the base is between 100° and 150°.

7. The vessel according to claim 2, wherein one or more protrusions are located on the base of at least one of the first arcuate portion or the second arcuate portion, the one or more protrusions being configured to generate the turbulent conditions in the wastewater in the at least one of the first arcuate portion or the second arcuate portion.

8. The vessel according to claim 7, wherein the one or more protrusions comprise S-shaped elongate raised portions extending substantially an entire distance across the base between the inner radius wall and the outer radius wall.

9. The vessel according to claim 1, wherein a ratio of surface area to volume in the first arcuate portion and the second arcuate portion are between approximately 0.15 m⁻¹ and 0.6 m⁻¹.

10. The vessel according to claim 1, wherein the first arcuate portion and the second arcuate portion are in fluid communication with one another via one or more wastewater passages passing through the weir portion.

11. The vessel according to claim 10, wherein the one or more wastewater passages are configured to allow a flow of liquid between the first arcuate portion and the second arcuate portion, but to reduce or eliminate movement of solid matter between the first arcuate portion and the second arcuate portion.

12. The vessel according to claim 1, wherein the one or more reagents comprise at least one of a source of, or a substrate produced by, and which stimulates activity of, one or more prokaryotic organisms.

13. The vessel according to claim 1, wherein the one or more reagents comprise a liquid fertiliser or biological substrate.

14. The vessel according to claim 1, wherein a second dosing device is located between opposed ends of the first arcuate portion, and a third dosing device is located at or adjacent the first end of the second arcuate portion.

15. The vessel according to claim 1, wherein a diameter of the vessel and a mass of the wastewater contained within the vessel is of sufficient size that the wastewater is affected by gravitational energy.

16. The vessel according to claim 15, wherein the wastewater in the vessel behaves in a tidal manner.

17. The vessel according to claim 1, wherein the biological activity includes at least one of fermentation reactions, reactions that harvest hydrogen ions or reactions that create one or more chemical substances that enhance the removal of the contaminants from the wastewater.

18. The vessel according to claim 1, wherein the removal of the contaminants from the wastewater results in formation of an output product, the output product including water and one or more output biological agents.

19. The vessel according to claim 18, wherein the output product is removed from the vessel via the water outlet.

20. A method for removing contaminants from wastewater, the method comprising the steps of:
providing a vessel for treatment of the wastewater, the vessel comprising a first arcuate portion, and a second arcuate portion, the first arcuate portion and the second arcuate portion being oriented relative to one another such that the vessel is substantially ring-shaped, and a second end of the first arcuate portion is spaced apart from a first end of the second arcuate portion by a weir portion, the vessel further comprising a water outlet located at or adjacent a second end of the second arcuate portion;
introducing a reagent into the wastewater, the reagent being configured at least one of to remove contaminants from the wastewater or to stimulate or catalyse one or more reactions with one or more biological agents within the wastewater that result in removal of the contaminants from the wastewater; and
generating turbulent conditions in the wastewater in the vessel, the turbulent conditions being conducive to fostering biological activity of the one or more biological agents, thereby contributing to removal of the contaminants from the wastewater by the one or more biological agents.
